(19) United States
(12) Patent Application Publication
(10) Pub. No.: US 2017/0374540 A1
(43) Pub. Date: Dec. 28, 2017

(54) METHOD AND DEVICE FOR SELECTING TERMINAL CAPABLE OF USING VAMOS

(71) Applicant: Samsung Electronics Co., Ltd., Suwon-si, Gyeonggi-do (KR)

(72) Inventor: Wonkyun SUK, Yongin-si (KR)

(21) Appl. No.: 15/545,835

(22) PCT Filed: Jan. 21, 2016
(86) PCT No.: PCT/KR2016/000629

§ 371 Date: Jul. 24, 2017

(30) Foreign Application Priority Data
Jan. 28, 2015 (KR) 10-2015-0013325

(51) Int. Cl. H04W 8/00; H04L 27/18; H04W 8/24; H04W 24/10

(52) U.S. Cl. CPC H04W 8/005; H04W 24/10; H04L 27/18; H04W 8/24

(57) ABSTRACT

Since a current GSM base station determines whether a terminal can remove interference using only a DARP information report of the terminal, the base station itself needs to determine whether the terminal is a VAMOS-executable terminal that can perform an interference removal function. The base station transmits a signal, together with a signal acting as interference, using an A-QPSK method, in order to determine whether the terminal can use a VAMOS function, and determines whether the terminal can receive an A-QPSK symbol, in consideration of a reception quality signal of a signal transmitted by the terminal.

### TECHNICAL FIELD

The present invention relates to Voice services over Adaptive Multiuser channels on One Slot (VAMOS) and, in particular, to a VAMOS-capable terminal selection method and device.

### BACKGROUND ART

Global system for mobile communications (GSM) is a second generation (2G) mobile communication technology standardized based on time division multiple access (TDMA).

Much research is being conducted on technologies for providing a service to multiple users simultaneously over a GSM network. One of such technologies is to multiplex two users onto one slot. This method makes it possible to serve two users alternately with a frame size reduced to half the original length (half rate), but it has drawbacks in that the decreased voice codec rate causes voice quality degradation and requires higher physical reception capability. In order to overcome these problems, a multiple-input multiple-output (MIMO) technique called voice services over adaptive multiuser channels on one slot (VAMOS) is proposed for serving two users simultaneously with a full rate codec.

VAMOS is a technique for multiplexing two users onto the same physical resource and transmitting the signals addressed to each of the two different users in I and Q phases, respectively, using adaptive quadrature phase shift keying (A-QPSK). In order to use the VAMOS technique, a base station needs a receiver with 2 reception antennas using gaussian minimum shift keying (GMSK), and a terminal needs a receiver capable of removing interference signals from an A-QPSK signal.

### DISCLOSURE OF INVENTION

### Technical Problem

The legacy base station designed to determine whether the terminal has an interference cancellation capability based on only the downlink advanced receiver performance (DARP) information cannot determine whether the terminal is a VAMOS-capable terminal. Therefore, there is a need of a method for allowing a base station to determine whether a terminal is a VAMOS-capable terminal.

### Solution to Problem

In accordance with an aspect of the present invention, a method of a base station for selecting a terminal capable of supporting voice services over adaptive multiuser channels on one slot (VAMOS) includes determining whether to transmit an adaptive quadrature phase shift keying (A-QPSK) signal to a terminal; transmitting, when a determination is made to transmit the A-QPSK signal, the A-QPSK signal in an A-QPSK symbol to the terminal; receiving received signal quality information corresponding to the A-QPSK signal from the terminal; and determining whether the terminal is a VAMOS-capable terminal based on the received signal quality information.

In accordance with another aspect of the present invention, a method of a terminal for receiving an adaptive quadrature phase shift keying (A-QPSK) signal includes receiving an A-QPSK signal contained in an A-QPSK symbol transmitted by a base station and transmitting received signal quality information corresponding to the A-QPSK signal to the base station.

In accordance with another aspect of the present invention, a base station for selecting a terminal capable of supporting voice services over adaptive multiuser channels on one slot (VAMOS) includes a transceiver which transmits and receives signals and a controller which determines whether to transmit an adaptive quadrature phase shift keying (A-QPSK) signal to a terminal and controls transmitting, when a determination is made to transmit the A-QPSK signal, the A-QPSK signal in an A-QPSK symbol to the terminal, receiving received signal quality information corresponding to the A-QPSK signal from the terminal, and determining whether the terminal is a VAMOS-capable terminal based on the received signal quality information.

In accordance with still another aspect of the present invention, a terminal for receiving an adaptive quadrature phase shift keying (A-QPSK) signal includes a transceiver which transmits and receives signals and a controller which controls receiving an A-QPSK signal contained in an A-QPSK symbol transmitted by a base station and transmitting received signal quality information corresponding to the A-QPSK signal to the base station.

### Advantageous Effects of Invention

The VAMOS-capable terminal selection method of the present invention is advantageous in that a base station is capable of extending a pool of users capable of being allocated VAMOS resources and controlling transit power in consideration of reception capabilities of the terminals in the VAMOS mode.

### BRIEF DESCRIPTION OF DRAWINGS

FIG. 1 is a flowchart illustrating an A-QPSK symbol transmission procedure of a base station for selecting a VAMOS-capable terminal;

FIG. 2 is a flowchart illustrating a procedure of a terminal for selecting a VAMOS-capable terminal;

FIG. 3 is a flowchart illustrating a procedure of a base station for receiving a measurement report transmitted for use in selecting a VAMOS-capable terminal;

FIG. 4 is a signal flow diagram illustrating a procedure of a base station for determining whether a terminal has a multiuser MIMO (MU-MIMO) capability;

FIG. 5A is a block diagram illustrating a configuration of a base station according to an embodiment of the present invention;

FIG. 5B is a block diagram illustrating a configuration of a base station according to another embodiment of the present invention;

FIG. 6A is a block diagram illustrating a configuration of a terminal according to an embodiment of the present invention; and

FIG. 6B is a block diagram illustrating a configuration of a terminal according to another embodiment of the present invention.

### MODE FOR THE INVENTION

Exemplary embodiments of the present invention are described in detail with reference to the accompanying drawings. Detailed descriptions of well-known functions and structures incorporated herein may be omitted to avoid obscuring the subject matter of the present invention. Further, the following terms are defined in consideration of the functionality in the present invention, and they may vary according to the intention of a user or an operator, usage, etc. Therefore, the definition should be made on the basis of the overall content of the present specification.

Although the description is directed to wireless communication systems, particularly a GSM and a 3^{rd} generation partnership project (3GPP) evolved terrestrial radio access network (E-UTRAN), it will be understood by those skilled in the art that the present invention can be applied even to other communication systems having a similar technical background and channel format, with a slight modification, without departing from the spirit and scope of the present invention.

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The GSM VAMOS is a technique for multiplexing two users on the same physical resources and requires pairing two terminals, which are capable of receiving A-QPSK symbols, of the two users. There are many A-QPSK symbol reception algorithms. For VAMOS pairing, the base station determines that the terminal that has reported the DARP information set to 1 in a Class mark for use in reporting terminal capability is a VAMOS-capable terminal.

In order to report the DARP information set to 1, it is necessary to meet the standard requirements; thus, there may be a terminal which reports the DARP information set to 0 because of a failure to meet the standard requirements even though it has an interference cancellation capability. Although most typical terminals that have a single antenna interference cancellation (SAIC) function as an algorithm for improving the signal reception capability by cancelling interference from the signal received with one antenna can receive A-QPSK symbols, only the latest models of terminals with enhanced signal reception capability can report the DARP information set to 1.

The present invention aims to make it possible for a base station to determine whether a terminal has the interference cancellation capability and VAMOS capability regardless of DARP information and to extend the pool of users capable of being allocated on VAMOS resources, thereby improving resource utilization efficiency and providing VAMOS services to more users.

The base station transmits to the terminal the information on the signals as potential interference along with the information addressed to the terminal in the A-QPSK mode and determines whether the terminal has the VAMOS capability to receive A-QPSK symbols in consideration of the reception quality signal which is transmitted by the terminal.

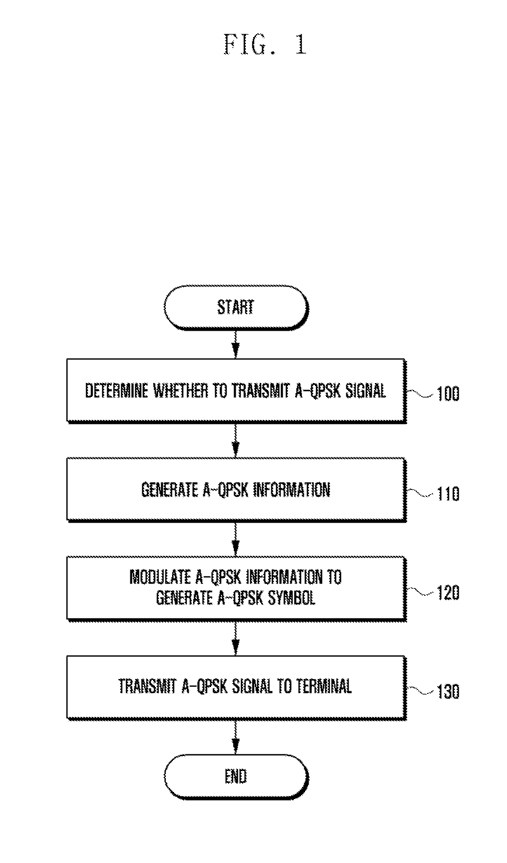

FIG. 1 is a flowchart illustrating an A-QPSK symbol transmission procedure of a base station for selecting a VAMOS-capable terminal.

In FIG. 1, the base station determines at step 100 whether to transmit an A-QPSK signal, which may cause interference to the terminal. The base station may make a determination to transmit the A-QPSK signal for making a determination on whether a terminal attempting initial access to a network or location update or registration has the interference cancellation capability. The base station may also make a determination to transmit an A-QPSK signal including control information or voice information to a user to which the control information or voice information (hereinafter, interchangeably referred to as data) is being currently transmitted. In detail, the base station may transmit an A-QPSK signal including system information-5 (SI-5) and system information-6 (SI-6) being delivered over a downlink-slow associated control channel (DL-SACCH). This is because the SI-5 and SI-6 are control signals broadcast periodically so that there is no need for a terminal, if the terminal receives them once, to receive the signals repeatedly; thus, any signal reception quality degradation caused by use of the A-QPSK mode transmission has little effect on the terminal. The base station may also transmit the A-QPSK signal along with discontinuous transmission silence description (DTX-SID) signaling. Transmitting the A-QPSK signal along with the DTX-SID signaling or SACCH information is convenient in that RX_REV_SUB (received signal power with absence of noise) or RX_QUAL_SUB (received signal quality with absence of noise) fed back by the terminal can be used as the received signal quality for transmitting the A-QPSK signal. The base station may transmit to the terminal the A-QPSK signal along with data. This is advantageous in that the base station can receive the quality feedback information corresponding to the data quickly after transmitting the A-QPSK signal, but this transmission is likely to degrade data reception quality. In consideration of the probability of downlink signal reception quality degradation caused by A-QPSK transmission, the base station has to transmit the A-QPSK signal only when it is guaranteed that the downlink signal quality is good enough to transmit the A-QPSK signal; thus, there is a need to configure a threshold value of downlink signal reception quality for making such a determination.

If it is determined to transmit the A-QPSK signal, the base station generates A-QPSK information at step 110. The A-QPSK information may be an arbitrarily generated random number or predetermined data known to both the base station and terminal and transmitted along with the control information or data. If there is no control signal or data to be transmitted to the terminal, the base station may transmit only the arbitrarily generated random number or predetermined data.

The base station modulates the A-QPSK information to generate an A-QPSK symbol at step 120. The base station transmits to the terminal the control signal or data addressed using a symbol on one of an in-phase (I) axis and a quadrature-phase (Q) axis and an A-QPSK signal using a symbol on the other as a potential interference to the terminal. If there is no control signal or data addressed to the terminal, the base station may transmit only the arbitrarily generated random number or predetermined data using the symbols on the I and Q axes. The base station may transmit the A-QPSK symbol conveying the A-QPSK signal to the terminal at step 130.

Here, the base station may adjust the size of the A-QPSK symbol as a potential interferer to the terminal to adjust the size of the interference to the terminal. If the size of the signal as a potential interferer is large, the terminal assumes that the interference to the desired signal is large. The base station adjusts the size of the A-QPSK symbol as a potential interferer to the terminal in the form of a strength of the interference power (this may be expressed as specification of maximum subchannel power imbalance ratio (SCPIR)) and stores this value.

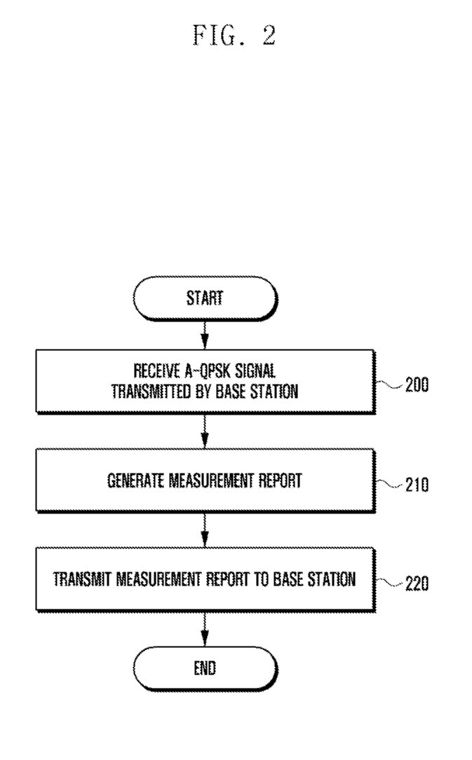

FIG. 2 is a flowchart illustrating a procedure of a terminal for selecting a VAMOS-capable terminal.

In FIG. 2, the terminal receives an A-QPSK signal at step 200, the A-QPSK signal being transmitted by a base station. The terminal receives symbols conveying the control information or data addressed thereto among the A-QPSK symbols, cancels interference caused by the A-QPSK symbol as an interferer using its interference cancellation algorithm, and generates a measurement report including received signal quality information at step 210. The measurement report may include RX_REV_SUB and RX_QUAL_SUB information. The terminal transmits the measurement report to the base station at step 220. The RX_REV_SUB information denotes the received signal power with the absence of noise and may be expressed by an integer in the range from 0 to 63. The greater is the value, the higher is the power level. The RX_QUAL_SUB denotes the received signal quality with the absence of noise and may be expressed by an integer in the range from 0 to 7. The smaller is the value, the higher is the quality level.

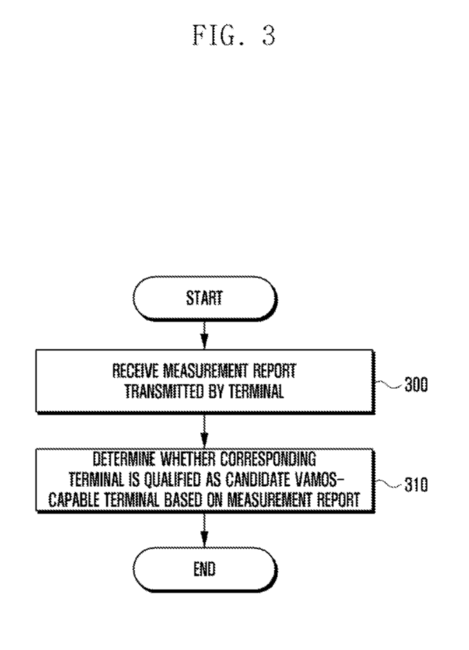

FIG. 3 is a flowchart illustrating a procedure of a base station for receiving a measurement report transmitted for use in selecting a VAMOS-capable terminal.

In FIG. 3, the base station receives a measurement report at step 300, the measurement report being transmitted by the terminal. The base station stores the RX_REV_SUB and RX_QUAL_SUB information contained in the measurement report according to the SCPIR determined based on the size of the A-QPSK symbol. The base station may determine at step 310 whether the terminal is qualified as a candidate VAMOS-capable terminal based on the measurement result. That is, the base station performs a measurement to determine a maximum received signal quality level of the terminal and stores the measurement result for use in determining the terminal as a candidate VAMOS-capable terminal when it is assumed that the terminal can receive the signal being conveyed by an A-QPSK symbol at a sufficiently good quality level. For example, if the SCPIR is 0 dB (i.e., interference signal is identical with the desired signal) and the RX_QUAL_SUB is equal to or less than 3, the base station may determine the terminal as a candidate VAMOS-capable terminal and store the identifier of the terminal.

The terminal's interference cancellation capability identified as described above may be used in power control for the case of providing the service to two terminals in the VAMOS mode. In the case that one of the VAMOS-paired terminals moves away from the base station, the base station increases the transmit powers for both the two terminals to provide the service. Particularly in the case that the other terminal moves close to the base station, the base station increases the transmit power for the corresponding terminal, resulting in waste of power. However, in the case that the base station knows the interference cancellation capabilities of each of the terminals, if the terminal moving close to the base station has a high interference cancellation capability, can cancel a large interference even when the base station provides the terminal moving away therefrom with the service at a high transmit power level, and this makes it possible to provide the service at a low power level, resulting in improvement of power utilization efficiency.

The base station may also select a VAMOS-capable terminal based on the feedback information including the received signal quality information corresponding to another downlink signal as well as the RX_REV_SUB and RX_QUAL_SUB information included in the aforementioned measurement report.

This method may also be applied to LTE.

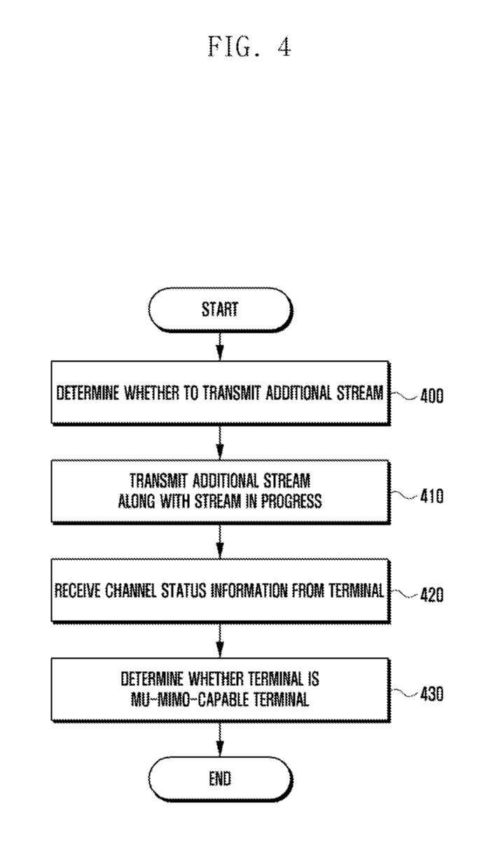

FIG. 4 is a signal flow diagram illustrating a procedure of a base station for determining whether a terminal has a multiuser MIMO (MU-MIMO) capability.

In FIG. 4, in the state where the base station is transmitting a first stream to a terminal, it determines at step 400 whether to generate a second stream, which may cause interference to the terminal. In consideration of the potential received signal quality degradation caused by interference to the terminal, the base station may determine to generate the second stream when the received signal quality is equal to or greater than a threshold value. The base station transmits the second stream along with the first stream addressed to the terminal simultaneously at step 410. The base station may transmit an arbitrarily generated random number or predetermined data using the second stream and, at this time, a matrix selected from a codebook for precoding is applied to the first stream to the terminal. The base station receives channel status information corresponding to the first stream from the terminal at step 420. The channel status information may include a channel quality indicator (CQI), a rank indicator (RI), and acknowledgement/negative acknowledgement (ACK/NACK) corresponding to the stream. The base station determines at step 430 whether the terminal is a MU-MIMO-capable terminal based on the channel status information. The base station may check the CQI for received signal quality with the presence of interference and, if the received signal quality is high even with the presence of interference, determine the terminal as a MU-MIMO-capable terminal. If an ACK corresponding to the first stream is received, this means that the terminal can receive signals; thus, the base station determines the terminal as a MU-MIMO-capable terminal.

Even with the received signal quality degradation probability, this method can be used to manage candidate precoding matrices applicable for the users of services with a long session such as a voice over internet protocol (VoIP) service or a video on demand (VOD) service in MU-MIMO LTE systems.

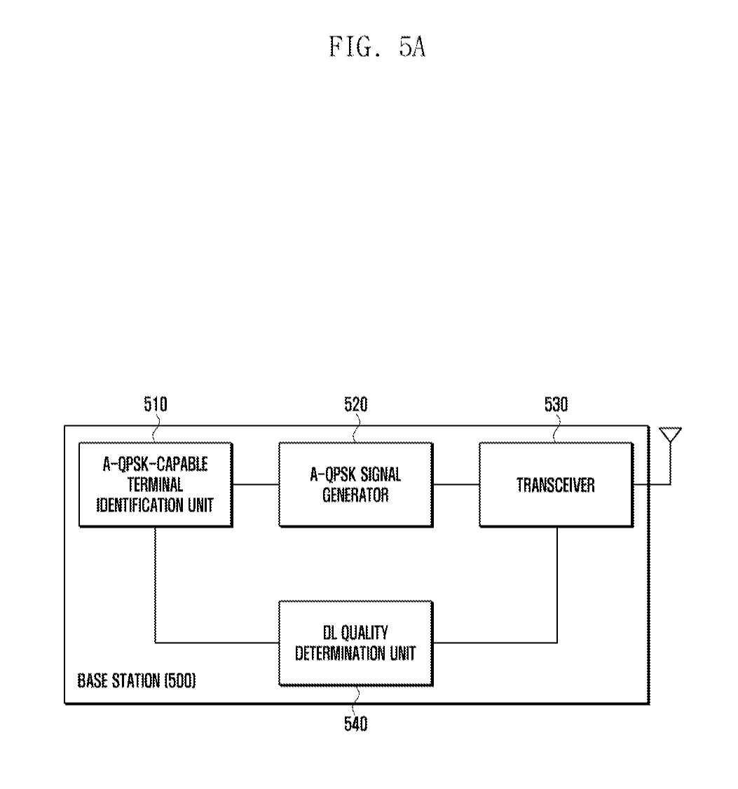

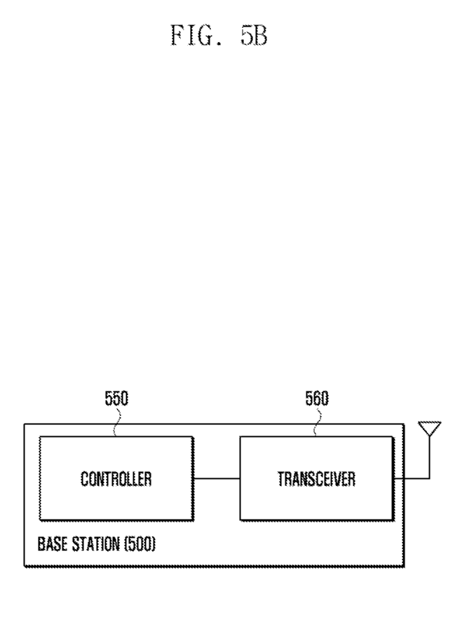

FIG. 5A is a block diagram illustrating a configuration of a base station according to an embodiment of the present invention.

As shown in FIG. 5A, the base station 500 includes an A-QPSK-capable terminal identification unit 510, an A-QPSK signal generator 520, a transceiver 530, and a downlink quality determination unit 540. The A-QPSK-capable terminal identification unit 510 determines whether to transmit an A-QPSK signal as a potential interference to the terminal and determines whether the terminal is qualified as a candidate VAMOS-capable terminal based on the received signal quality information. The A-QPSK signal generator 520 generates an A-QPSK signal according to the A-QPSK signal transmission determination made by the A-QPSK-capable terminal identification unit 510. The transceiver 530 modulates the A-QPSK signal generated by the A-QPSK signal generator 520 and the control signal or voice signal addressed to the terminal into an A-QPSK symbol, transmits the A-QPSK symbol to the terminal, and receives a measurement report transmitted by the terminal. The downlink quality determination unit 540 transfers the received signal quality information contained in the measurement report transmitted by the terminal to the A-QPSK-capable terminal identification unit 510.

FIG. 5B is a block diagram illustrating a configuration of a base station according to another embodiment of the present invention.

As shown in FIG. 5B, the base station 500 includes a controller 550 and a transceiver 560. The transceiver 560 modulates the A-QPSK signal generated by an A-QPSK signal generator and the control signal or voice signal addressed to a terminal into an A-QPSK symbol, transmits the A-QPSK symbol to the terminal, and receives a measurement report transmitted by the terminal. The controller 550 determines whether to transmit an A-QPSK signal as a potential interference to the terminal, generates the A-QPSK signal, and determines whether the terminal is qualified as a candidate VAMOS-capable terminal based on the received signal quality information included in the measurement report transmitted by the terminal.

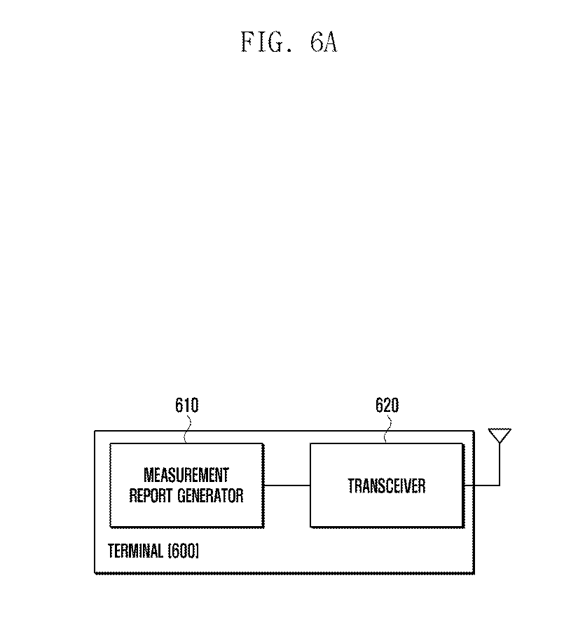

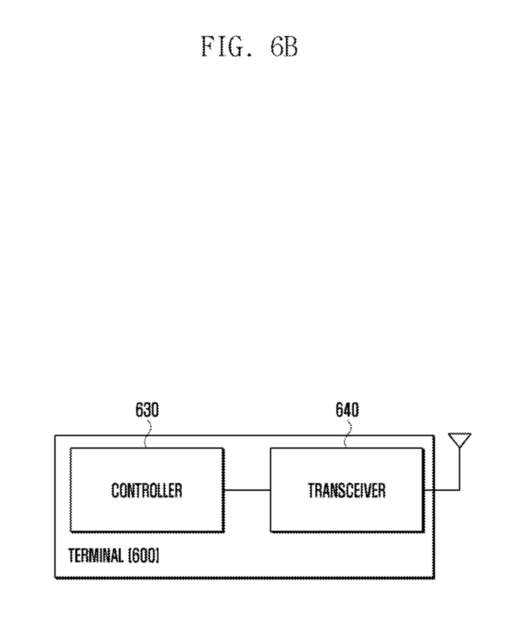

FIG. 6A is a block diagram illustrating a configuration of a terminal according to an embodiment of the present invention.

As shown in FIG. 6A, the terminal 600 includes a measurement report generator 610 and a transceiver. The transceiver 620 receives an A-QPSK symbol transmitted by a base station and transmits a measurement report generated by the terminal to the base station. The measurement report generator 610 generates a measurement report including received signal quality information.

FIG. 6B is a block diagram illustrating a configuration of a terminal according to another embodiment of the present invention.

As shown in FIG. 6A, the terminal 600 includes a controller 630 and a transceiver 640. The transceiver 640 receives an A-QPSK symbol transmitted by a base station and transmits a measurement report generated by the terminal 600 to the base station. The controller 640 may generate a measurement report including received signal quality information.

1) A method of a base station for selecting a terminal capable of supporting voice services over adaptive multiuser channels on one slot (VAMOS), the method comprising:
determining whether to transmit an adaptive quadrature phase shift keying (A-QPSK) signal to a terminal;
transmitting, if a determination is made to transmit the A-QPSK signal, the A-QPSK signal in an A-QPSK symbol to the terminal;
receiving received signal quality information corresponding to the A-QPSK signal from the terminal; and
determining whether the terminal is a VAMOS-capable terminal based on the received signal quality information.

2) The method of claim 1, wherein transmitting the A-QPSK signal comprises modulating control information or data and an interference signal to generate the A-QPSK symbol in which the control information or data addressed to the terminal is mapped to a symbol on one of an in-phase (I) axis and quadrature-phase (Q) axis and the interference signal is mapped to a symbol on the other.

3) The method of claim 2, wherein transmitting the A-QPSK signal comprises adjusting a transmit power for the symbol carrying the interference signal to adjust an interference amount affecting the terminal.

4) The method of claim 1, wherein determining whether to transmit the A-QPSK signal comprises determining to transmit the A-QPSK signal along with system information-5 (SI-5) and system information-6 (SI-6) or discontinuous transmission silence description (DTX-SID) signaling.

5) The method of claim 4, wherein the received signal quality information comprises RX_REV_SUB or RX_QUAL_SUB contained in a measurement report transmitted from the terminal to the base station.

6) A method of a terminal for receiving an adaptive quadrature phase shift keying (A-QPSK) signal, the method comprising:
receiving an A-QPSK signal contained in an A-QPSK symbol transmitted by a base station; and
transmitting received signal quality information corresponding to the A-QPSK signal to the base station.

7) The method of claim 6, wherein the A-QPSK signal is transmitted along with
system information-5 (SI-5) and system information-6 (SI-6) or discontinuous transmission silence description (DTX-SID) signaling.

8) The method of claim 7, wherein the received signal quality information comprises RX_REV_SUB or RX_QUAL_SUB contained in a measurement report transmitted from the terminal to the base station.

9) A base station for selecting a terminal capable of supporting voice services over adaptive multiuser channels on one slot (VAMOS), the base station comprising:
a transceiver to transmit and receive signals; and
a controller coupled with the transceiver and configured to determine whether to transmit an adaptive quadrature phase shift keying (A-QPSK) signal to a terminal, transmit, if a determination is made to transmit the A-QPSK signal, the A-QPSK signal in an A-QPSK symbol to the terminal, receive received signal quality information corresponding to the A-QPSK signal from the terminal, and determine whether the terminal is a VAMOS-capable terminal based on the received signal quality information.

10) The base station of claim 9, wherein the controller controls modulating control information or data and an interference signal to generate the A-QPSK symbol in which the control information or data addressed to the terminal is mapped to a symbol on one of an in-phase (I) axis and quadrature-phase (Q) axis and the interference signal is mapped to a symbol on the other.

11) The base station of claim 10, wherein the controller controls a transmit power for the symbol carrying the interference signal to adjust an interference amount affecting the terminal.

12) The base station of claim 9, wherein the controller determines to transmit the A-QPSK signal along with system information-5 (SI-5) and system information-6 (SI-6) or discontinuous transmission silence description (DTX-SID) signaling.

13) The base station of claim 12, wherein the received signal quality information comprises RX_REV_SUB or RX_QUAL_SUB contained in a measurement report transmitted from the terminal to the base station.

14) A terminal for receiving an adaptive quadrature phase shift keying (A-QPSK) signal, the terminal comprising:
a transceiver transmit and receive signals; and
a controller coupled with the transceiver and configured to receive an A-QPSK signal contained in an A-QPSK symbol transmitted by a base station and transmit received signal quality information corresponding to the A-QPSK signal to the base station.

15) The terminal of claim 14, wherein the A-QPSK signal is transmitted along with system information-5 (SI-5) and system information-6 (SI-6) or discontinuous transmission silence description (DTX-SID) signaling.

16) The terminal of claim 15, wherein the received signal quality information comprises RX_REV_SUB or RX_QUAL_SUB contained in a measurement report transmitted from the terminal to the base station.
